(19) United States
(12) Patent Application Publication
(10) Pub. No.: US 2025/0226873 A1
(43) Pub. Date: Jul. 10, 2025

(54) CUSTOMER PREMISES EQUIPMENT SPECIFIC BEAM MANAGEMENT FOR FIXED WIRELESS ACCESS

(71) Applicant: Samsung Electronics Co., Ltd., Suwon-si (KR)

(72) Inventors: Ahmad AlAmmouri, Richardson, TX (US); Jianhua Mo, Allen, TX (US); Mustafa Ozkoc, The Colony, TX (US); Shouvik Ganguly, Frisco, TX (US); Young Han Nam, Plano, TX (US)

(21) Appl. No.: 18/983,245

(22) Filed: Dec. 16, 2024

Related U.S. Application Data
(60) Provisional application No. 63/619,204, filed on Jan. 9, 2024.

(51) Int. Cl. H04B 7/06; H04L 5/00

(52) U.S. Cl. CPC H04B 7/06952; H04L 5/0051

(57) ABSTRACT

Methods and apparatuses for reporting channel state information (CSI) associated with sub-configurations in wireless communication systems. A method includes receiving classification information associated with at least one user equipment (UE); providing of, based on the classification information, whether the at least one UE is a mobile UE or a fixed wireless access UE (FWA UE) comprising a customer premises equipment (CPE); and selecting, based on the determination, at least one of a beam codebook, a beam search procedure, or a beam search periodicity for a beam management operation corresponding to the mobile UE or the FWA UE.

### CROSS-REFERENCE TO RELATED APPLICATIONS AND CLAIM OF PRIORITY

The present application claims priority to U.S. Provisional Patent Application No. 63/619,204, filed on Jan. 9, 2024. The contents of the above-identified patent documents are incorporated herein by reference.

### TECHNICAL FIELD

The present disclosure relates generally to wireless communication systems and, more specifically, the present disclosure relates to customer premises equipment (CPE) specific beam management for fixed wireless access (FWA) in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to CPE specific beam management for FWA in wireless communication systems.

In one embodiment, a base station (BS) in a wireless communication system is provided. The BS comprise a transceiver configured to receive classification information associated with at least one user equipment (UE). The BS further comprises a processor operably coupled to the transceiver, the processor configured to: provide a determination, based on the classification information, of whether the at least one UE is a mobile UE or a FWA UE comprising a CPE, and select, based on the determination, at least one of a beam codebook, a beam search procedure, or a beam search periodicity for a beam management operation corresponding to the mobile UE or the FWA UE.

In another embodiment, a method of a BS in a wireless communication system is provided. The method comprises: receiving classification information associated with at least one UE; providing a determination of, based on the classification information, whether the at least one UE is a mobile UE or a FWA UE comprising a CPE; and selecting, based on the determination, at least one of a beam codebook, a beam search procedure, or a beam search periodicity for a beam management operation corresponding to the mobile UE or the FWA UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of the BS to decide the beam codebook in MAC layer based on the UE class that passed from upper layers according to various embodiments of the present disclosure;

FIG. 8 illustrates an example of the BS to decide the beam codebook in MAC layer based on the beam codebook ID input that passed from upper layers according to various embodiments of the present disclosure;

FIG. 9 illustrates an example of the BS to decide the beam codebook in upper layers that is then passed to the MAC layer according to various embodiments of the present disclosure;

FIG. 10 illustrates an example of the BS to decide the beam codebook in jointly in upper layers and the MAC layers that is then passed to the MAC layer according to various embodiments of the present disclosure;

FIG. 11 illustrates an example of BS MAC layer to perform the same CSI-RS beam search process regardless of the UE class with different beam codebook for each class according to various embodiments of the present disclosure;

FIG. 12 illustrates an example of BS MAC layer to perform the same CSI-RS beam search process taking into account the previous serving beams and the CPE locations for the FWA case according to various embodiments of the present disclosure;

FIG. 13 illustrates an example of MAC layer to perform two steps of CSI-RS beam refinement for CPEs according to various embodiments of the present disclosure;

FIG. 14 illustrates an example of MAC layer to perform two steps of CSI-RS beam refinement for CPEs and the first refinement process is common for the different UE classes according to various embodiments of the present disclosure;

FIG. 15 illustrates an example of MAC layer to perform two steps of CSI-RS beam refinement or one based on a control signal from upper layer and the first refinement process is common for the different UE classes and the second is triggered by a control flag passed from upper layers according to various embodiments of the present disclosure;

FIG. 16 illustrates an example of MAC layer to performs two steps of CSI-RS beam refinement or one based on a control signal from upper layers and the first refinement process is common for the different UE classes and the second is triggered by a control flag passed from upper layers according to various embodiments of the present disclosure;

FIG. 17 illustrates an example of test area where a BS is located at the origin according to various embodiments of the present disclosure;

FIG. 18 illustrates an example of 2D beam pattern for the 160-beam codebook according to various embodiments of the present disclosure;

FIG. 19 illustrates an example of 2D beam pattern for the 640-beam codebook according to various embodiments of the present disclosure;

FIG. 20 illustrates an example of 2D beam pattern for the 2560-beam codebook

according to various embodiments of the present disclosure;

FIG. 21 illustrates an example of beam gain CDF for the different codebooks over the coverage area of interest according to various embodiments of the present disclosure;

FIG. 22 illustrates an example of median SNR for different beamforming schemes for LOS and NLOS CPEs according to various embodiments of the present disclosure;

FIG. 23 illustrates an example of 5%-tile SNR for different beamforming schemes for LOS and NLOS CPEs according to various embodiments of the present disclosure; and

FIG. 24 illustrates a flowchart of a BS method for CPE specific beam management for FWA according to various embodiments of the present disclosure.

### DETAILED DESCRIPTION

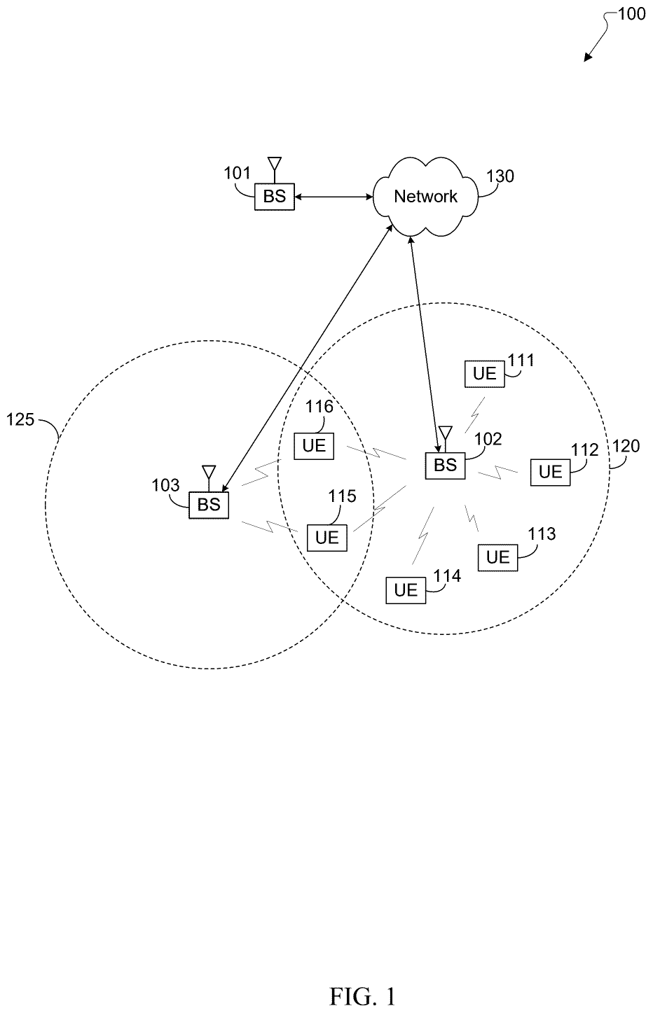

FIG. 1 through FIG. 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band.

For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 includes circuitry, programing, or a combination thereof, to support CPE specific beam management for FWA in wireless communication systems. Additionally, one or more of the UEs 111-116 includes circuitry, programing, or a combination thereof, for CPE specific beam management for FWA in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

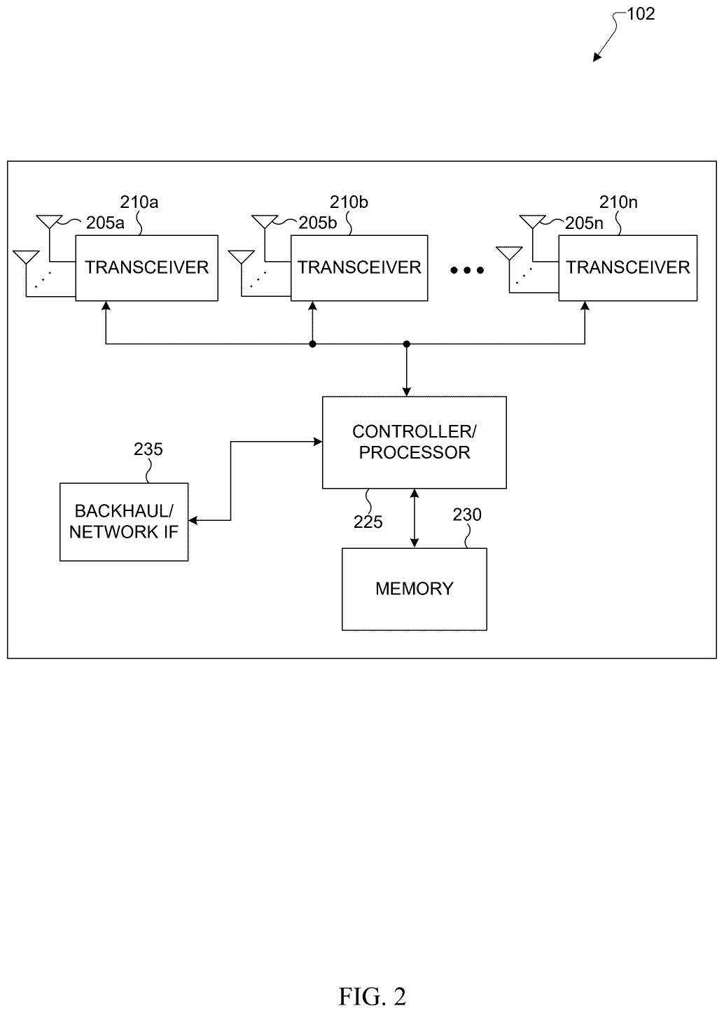

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support CPE specific beam management for FWA in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

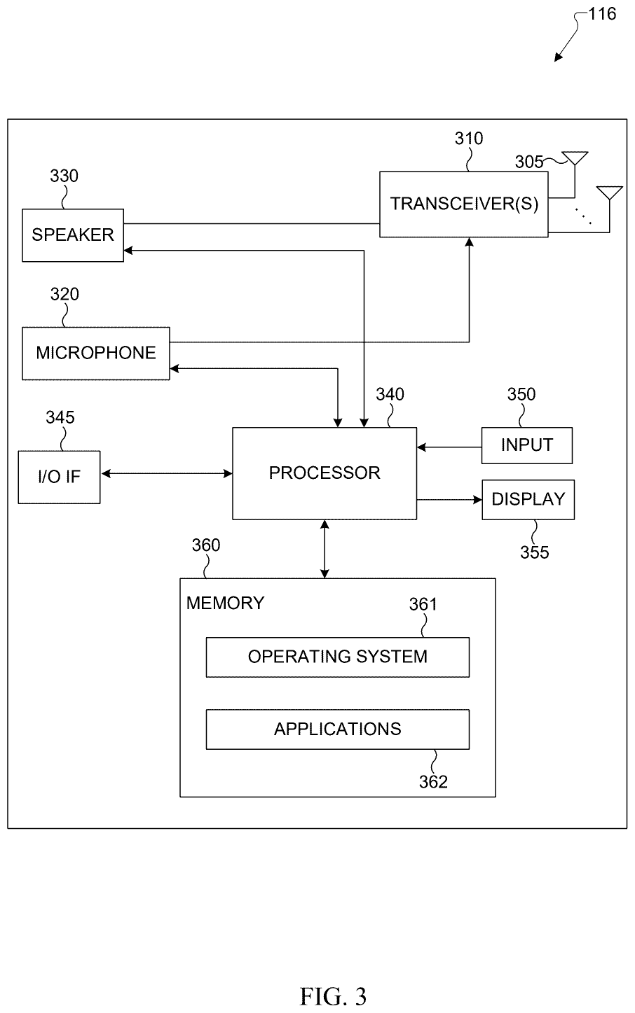

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

In various embodiments, the processor 340 may execute processes to perform reporting of CSI associated with sub-configurations in wireless communication systems as described in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

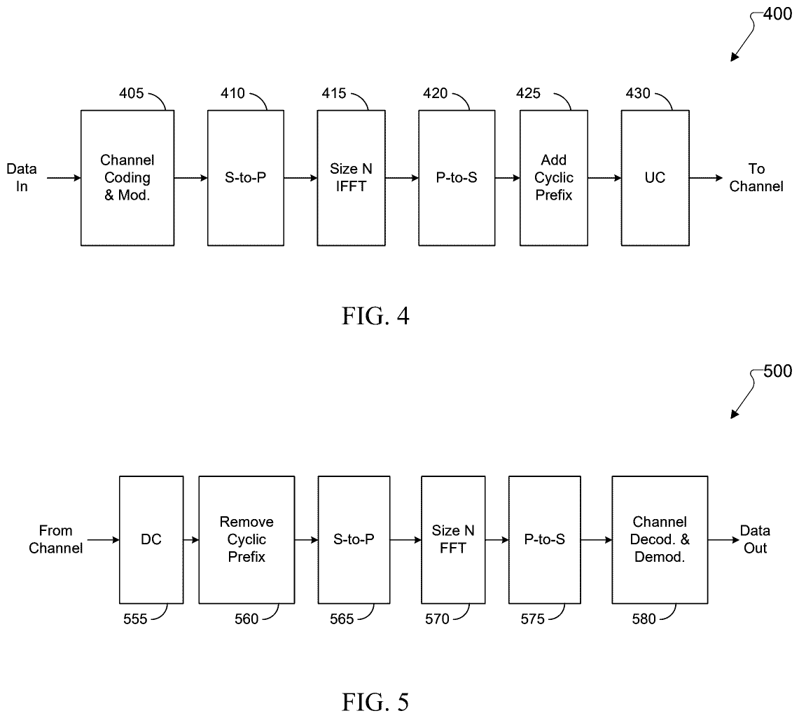

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to flexible synchronization signal and system information transmission in wireless communication systems.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information-reference signal (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

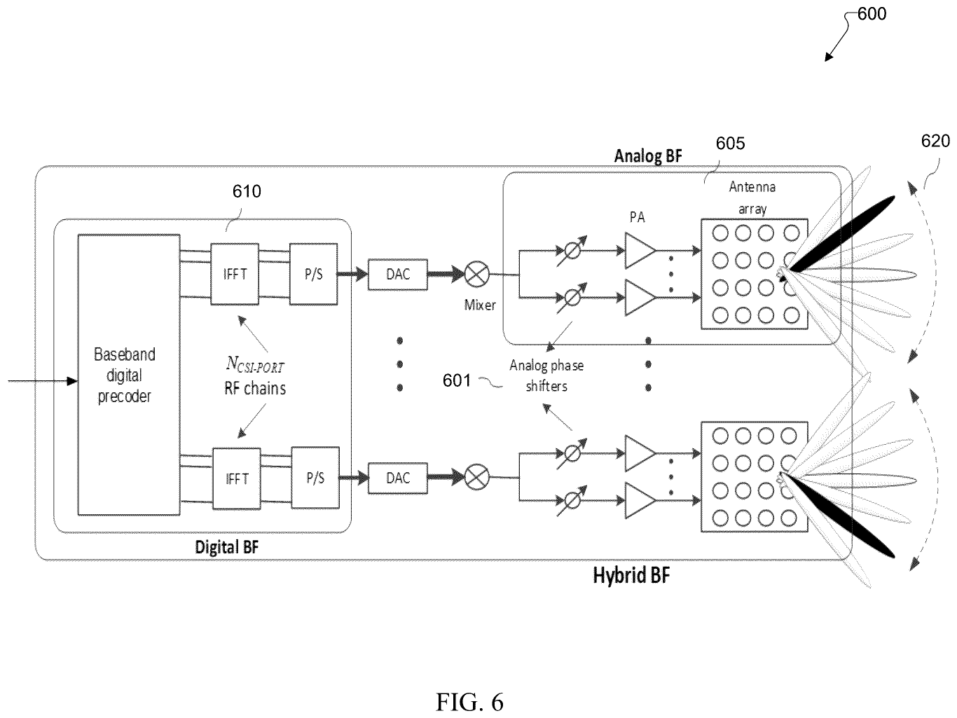

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

MIMO technologies have a key role in boosting system throughput both in NR and LTE and such a role may continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

A fixed wireless access (FWA) in 5G in a growing technology that leverages the high speed, low-latency capabilities of the 5G cellular network to provide reliable broadband connectivity to homes and businesses. Unlike other wired solutions, FWA utilizes radio signals transmitted between the base station (BS) and the customer premises equipment (CPE), eliminating the need for physical cables and offering deployment flexibility. The innovative approach of FWA promises to revolutionize internet connectivity by delivering high-performance broadband in both urban and rural areas and unlocking new possibilities for seamless communication and connectivity.

Moreover, 5G FWA takes a leap forward with the integration of millimeter-wave (mmWave) spectrum bands. MmWave FWA operates t high frequencies, e.g., 28 and 39 GHz, with large bandwidth, enabling faster data transmission rates and increased network capacity. While mmWave signals have shorter range and are susceptible to blockages, advancement in beamforming and antenna designs enhance signal propagation, making mmWave FWA a viable solution for delivering internet with high speeds. This makes it particularly well-suited for urban environment where the high-frequency bands can be harnessed to meet the ever-growing demand for bandwidth-intensive applications like augmented reality, virtual reality, and ultra-high-definition video streaming. For rural areas, the favorable channel conditions make mm Wave FWA a great solution for covering wide areas with broadband internet, where wired infrastructure is not available, bridging the digital divide. The combination of 5G and mmWave FWA heralds a new era of broadband connectivity, offering unprecedented speed and reliability to end-users.

Despite its promising capabilities, mmWave FWA encounters notable challenges, similar to 5G mobile communications. The shorter wavelength of mmWave results in reduced coverage area and increased susceptibility to signal blockages by obstacles like buildings and foliage. This necessitates a dense network of small cells for effective deployment, raising the infrastructure costs and complicating the network planning. Additionally, mm Wave signals exhibit higher atmospheric absorption, leading to signal degradation in adverse weather conditions. These challenges among others resulted in limited commercial success for utilizing mmWave for mobile 5G so far. Hence, addressing these hurdles is useful for unblocking the full potential of 5G FWA and ensuring consistent high-speed connectivity in diverse environment.

Overcoming the aforementioned challenges requires solutions such as advanced beamforming, dynamic spectrum sharing, and ongoing advancement in hardware design to enhance the resilience and reliability of mmWave FWA networks. An aspect is utilizing the features of mmWave FWA which makes it unique relative to mobile 5G. For example, CPEs can have more advance antennas and signal processing capabilities relative to the mobile devices, which enables more advanced beamforming techniques and antenna designs. Furthermore, mmWave CPEs can be power-plugged not relying on limited battery power.

Another aspect of mmWave FWA is the static location of CPEs, giving the network prior knowledge of the CPEs locations and enabling careful CPE deployment location ensuring favorable channel conditions. For example, rooftop deployment in rural areas eliminate the possibly of frequency blockages due to humans and vehicles. This results in larger channel coherence time mitigating the need for frequent beam training. Hence, to avoid the fate of mmWave 5G for mobile devices, special designs are needed exploiting the unique aspects of mmWave FWA.

In the present disclosure, one embodiment provides classifying, via a BS, users as mobile UEs or CPEs (i.e., FWA UEs), then using a different beam codebook, produced by a respective beam codebook generation process, for different classifications of users. Another embodiment provides classifying, via a BS, users as mobile UEs and CPEs (i.e., FWA UEs), then using a different beam search procedure for different classifications of users. Yet another embodiment provides classifying, via a BS, users as mobile UEs and CPEs (i.e., FWA UEs), then using a different SSB/CSI-RS beam search periodicity for different classifications of users.

In one embodiment, a method for the BS to classify the users' equipment into different classes, then use a different beam codebook for different UE classes or more generally, use a different beam codebook generation process for different classes. For example, the BS could classify UEs into mobile and CPE and use different NB codebook (CSI-RS beams) for each class.

In one embodiment, a method for the BS to classify the users' equipment into different classes, then use a different beam search procedure for different UE classes. For example, the BS could classify UEs into mobile and CPE. In one example, the BS could use a single CSI-RS beam codebook to identify the best CSI-RS beam for mobile UEs and multiple layered codebooks for CPEs.

In one embodiment, a method for the BS to classify the users' equipment into different classes, then use a different beam search periodicity for different UE classes. For example, the BS could classify UEs into mobile and CPE. In one example, the BS perform beam search less frequently for CPEs relative to mobile UEs exploiting the potentially larger channel coherence time in FWA.

The BS classifies UEs into different classes. The classification could be based on any of the digital or physical IDs (e.g., subscriber profile ID) reported by the UE once it connects to the network, or the BS could deduce the UE class from the UE capability report. The BS could have an arbitrary number of classes, but the case of two classes may be provided; mobile UE and CPE. The BS could maintain a lookup table that maps each connected UE to its class. In this embodiment, the BS is assumed to the use the same SSB beam codebook for all the UE classes. Hence, the only possible difference between the classes is the CSI-RS beam codebooks.

For the other step (i.e., mobile UEs), the BS has a dedicated CSI-RS beam codebook that is used for refining the SSB beam. The beam codebook could be stored in a table with each beam ID mapped to the set of phase shifter weights used to configure the RF to form this beam. Alternatively, the beam ID could be mapped to the pointing angle of this beam, which is then used in the medium access control (MAC) or high physical (PHY) layers to generate the needed phase shifter weights.

In such embodiment, the BS stores or generates CSI-RS beam codebooks that are only used for CPEs for the purpose of FWA. This beam could be designed exploiting the unique characteristics of FWA and CPEs.

In one example of codebook size, the codebook size could be much larger in the FWA resulting in higher beam gains towards the CPEs, but also could increase the beam search overhead. However, due to the large coherence time in FWA, beam sweeping could be done with much larger periodicity.

In one example of coverage region, the codebook could be designed with prior knowledge of the environment. In one example, a separate codebook could be designed for rural and semi-rural areas, where rooftop heights are much less that the BS. This could be exploited while designing the codebook by focusing the coverage region below the BS horizon. In another example, the prior knowledge of the CPEs locations could be exploited by stacking more beams in directions of deployed CPEs.

Note that the procedure of beam refinement, i.e., CSI-RS beam sweeping procedure, could be the same for the different UE classes, or could be class-dependent as disclosed in the embodiment. Depending on the signaling between the MAC layer, i.e., L2, and the upper layers (L3 and above), different examples are provided for implementations.

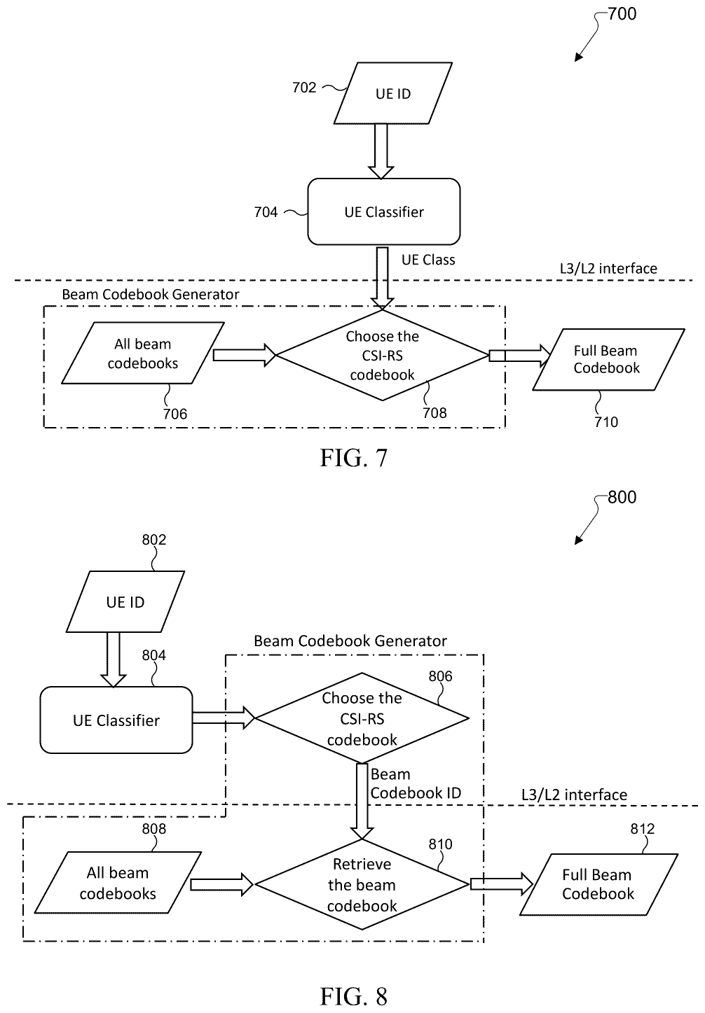

The UE class can be found in upper layers (L3 and above) then passed to the MAC layer, which decides which beam codebook it may use based on the UE class. In this case, a mapping between the UE class and beam codebooks is available at the MAC layer. Also, the beam codebooks in this case are calculated or stored in the MAC layer. The block diagram for this example is shown in FIG. 7.

FIG. 7 illustrates an example of the BS to decide the beam codebook in MAC layer 700 based on the UE class that passed from upper layers according to various embodiments of the present disclosure, as may be performed by a BS (e.g., 101-103 as illustrated in FIG. 1). An embodiment of the BS to decide the beam codebook in MAC layer 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, the BS decides the beam codebook in MAC layer based on the UE class, which passed from upper layers. In step 702, the BS identifies the UE ID and classifies the UE in step 704. Subsequently, the BS chooses the CSI-RS codebook in step 708 based on information of all beam codebook in step 706 and, in step 710, the BS determines a full beam codebook.

Compared to the other approaches, the beam codebook generator block takes the UE class as an input to determine the beam codebook to be used. The output is the CSI-RS beam that may be used by the MAC layer to determine the best CSI-RS beam to be used for each UE. Note that the beam codebook generator block is fully implemented in the MAC layer, i.e., L2, in this case. Furthermore, the beam codebook generator block could generate multiple CSI-RS beam codebooks depending on the implementation of the beam search procedure as explained in embodiments of the present disclosure.

In one example, the beam codebook ID could be passed to the MAC layer, which is used to determine which CSI-RS beam codebook to use. The block diagram for this example is shown in FIG. 8. Note that in this case, the beam codebook generator block is joint between the L2 and L3. Hence, L2 is oblivious to the UE class while choosing the beam codebook. Furthermore, the beam codebook generator block could generate multiple CSI-RS beam codebooks depending on the implementation of the beam search procedure as mentioned embodiments of the present disclosure.

FIG. 8 illustrates an example of the BS to decide the beam codebook in MAC layer 800 based on the beam codebook ID input that passed from upper layers according to various embodiments of the present disclosure, as may be performed by a BS (e.g., 101-103 as illustrated in FIG. 1). An embodiment of the UE BS to decide the beam codebook in MAC layer 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the BS decides the beam codebook in MAC layer based on the beam codebook ID input, which passed from upper layers. In step 802, the BS identifies the UE ID and classifies the UE in step 804. Subsequently, the BS chooses the CSI-RS codebook in step 806. In step 810, the BS retrieves the beam codebook based on information of all beam codebook in step 808 and, in step 812, the BS determines a full beam codebook.

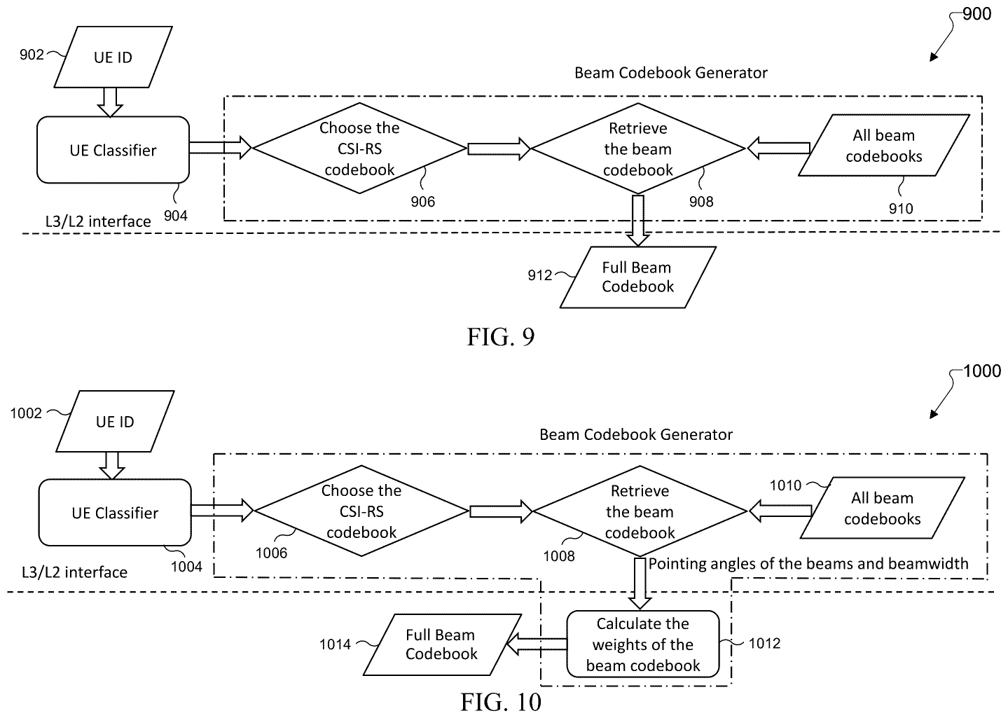

Alternatively, the beam codebook itself could be passed to the MAC layer, so the MAC layer in this case is oblivious to the UE class information. Moreover, all codebooks are stored in upper layers which saves the memory in the MAC layer at the expense of more signaling between the layers since the whole codebook needs to be passed to the MAC layer. This example is shown in FIG. 9. Furthermore, the beam codebook generator block could generate multiple CSI-RS beam codebooks depending on the implementation of the beam search procedure as mentioned embodiments of the present disclosure.

FIG. 9 illustrates an example of the BS to decide the beam codebook in upper layers 900 that is then passed to the MAC layer according to various embodiments of the present disclosure, as may be performed by a BS (e.g., 101-103 as illustrated in FIG. 1). An embodiment of the BS to decide the beam codebook in upper layers 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, the BS decides the beam codebook in upper layers, which is then passed to the MAC layer. In step 902, the BS identifies the UE ID and classifies the UE in step 904. Subsequently, the BS chooses the CSI-RS codebook in step 906. In step 908, the BS retrieves the beam codebook based on information of all beam codebook in step 910 and, in step 912, the BS determines a full beam codebook.

To reduce the signaling between the MAC and upper layers without consuming the memory in the MAC layer, upper layers could pass the pointing angles and the beamwidth of each beam in the codebooks to the MAC layer. Then using this information, the beam codebook is calculated in the MAC layer. This example is shown in FIG. 10. Note that in this case, the beam codebook generator block is joint between the MAC and upper layers. Furthermore, the beam codebook generator block could generate multiple CSI-RS beam codebooks depending on the implementation of the beam search procedure as explained in embodiments of the present disclosure.

FIG. 10 illustrates an example of the BS to decide the beam codebook in jointly in upper layers and the MAC layers 1000 that is then passed to the MAC layer according to various embodiments of the present disclosure, as may be performed by a BS (e.g., 101-103 as illustrated in FIG. 1). An embodiment of the BS to decide the beam codebook in jointly in upper layers and the MAC layers 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, in step 1002, the BS identifies the UE ID and classifies the UE in step 1004. Subsequently, the BS chooses the CSI-RS codebook in step 1006. In step 1008, the BS retrieves the beam codebook based on information of all beam codebook in step 1010 and, in step 1012, the BS calculates the weights of the beam codebook. Finally, in step 1014, the BS determines a full beam codebook.

Similar to such embodiments of the present disclosure, the BS classifies the UEs into different classes (e.g., mobile UEs and CPEs). However, the BS performs a different beam search procedure based on the UE class. The SSB beam search process is assumed to be common for all UE classes. For mobile UEs, two-step hierarchical search is currently used, i.e., the BS searched its SSB beams (wide beams) first, then based on the best SSB, it searches a subset of CSI-RS beams (narrow beams). The BS could still adopt the same procedure for mobile UEs but follow a different procedure for CPE beams.

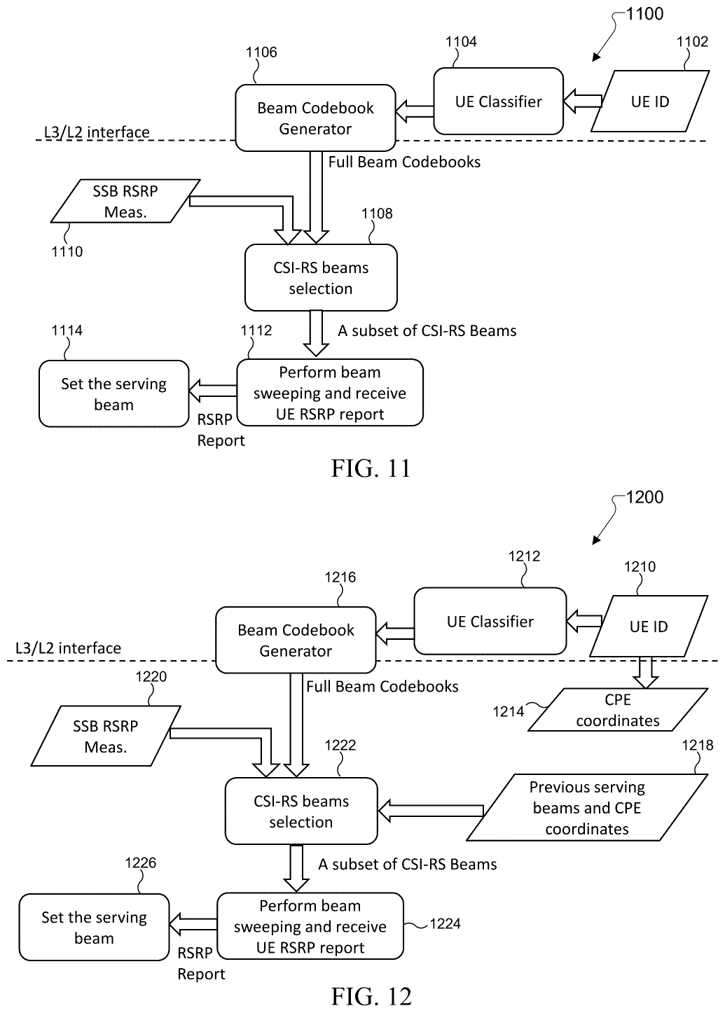

In such embodiments, only the SSB beams are commonly used for the mobile UEs and CPEs. In one example, the BS could use one CSI-RS beam codebook for CPEs that could have the same or different size as the mobile CSI-RS beam codebook. This example is shown in FIG. 11. Note that any of the embodiments of the present disclosure can be used for the beam codebook generator block.

FIG. 11 illustrates an example of BS MAC layer to perform the same CSI-RS beam search process 1100 regardless of the UE class with different beam codebook for each class according to various embodiments of the present disclosure, as may be performed by a BS (e.g., 101-103 as illustrated in FIG. 1). An embodiment of the BS MAC layer to perform the same CSI-RS beam search process 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the BS MAC layer performs the same CSI-RS beam search process regardless of the UE class, but with different beam codebook for each class. In step 1102, the BS identifies the UE ID and classifies the UE in step 1104. Subsequently, in step 1106, the BS generates a beam codebook. Subsequently, the BS selects the CSI-RS beams in step 1108 based on information of the SSB RSRP measurement in step 1110. In step 1112, the BS performs, based on a subset of CSI-RS beams, sweeping operation and receives the UE RSRP report. In step 1114, the BS sets the serving beam based on the RSRP report.

Note that the CSI-RS beams selection block selects a subset of CSI-RS beams from the codebook based on the SSB RSRP measurements for each UE. In one example of design, this block could be merged with the beam codebook generator block, such that the CSI-RS codebook is generated given the SSB RSRP measurements for each UE, i.e., a separate codebook is generated for each UE. This merging of blocks can be applied for all the embodiments and examples in the present disclosure.

As illustrated in FIG. 11, the BS MAC layer performs the same CSI-RS beam search process regardless of the UE class, but with different beam codebook for each class.

In another example, the MAC layer could receive the CPE coordinates from upper layers and previous serving beams and use them to enhance the beam refinement process. This example is shown in FIG. 12. Note that CSI-RS beams selection block can take as input the CPE coordinates and the previous serving beams in all of the following embodiments and examples of the present disclosure. Furthermore, this block could use a machine-learning based approach for down-selecting the beams. This is also applicable for all the different examples in this embodiment.

FIG. 12 illustrates an example of BS MAC layer to perform the same CSI-RS beam search process 1200 taking into account the previous serving beams and the CPE locations for the FWA case according to various embodiments of the present disclosure, as may be performed by a BS (e.g., 101-103 as illustrated in FIG. 1). An embodiment of the BS MAC layer to perform the same CSI-RS beam search process 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, the BS MAC layer performs the same CSI-RS beam search process taking into account the previous serving beams and the CPE locations for the FWA case.

As illustrated in FIG. 12, in step 1210, the BS identifies the UE ID and classifies the UE in step 1212 and performs the CPE coordination in step 1214. Subsequently, in step 1216, the BS generates a beam codebook. Subsequently, the BS selects the CSI-RS beams in step 1222 based on information of the SSB RSRP measurement in step 1220 and previous serving beams and CPE coordinates in step 1218. In step 1224, the BS performs, based on a subset of CSI-RS beams, sweeping operation and receives the UE RSRP report. In step 1226, the BS sets the serving beam based on the RSRP report.

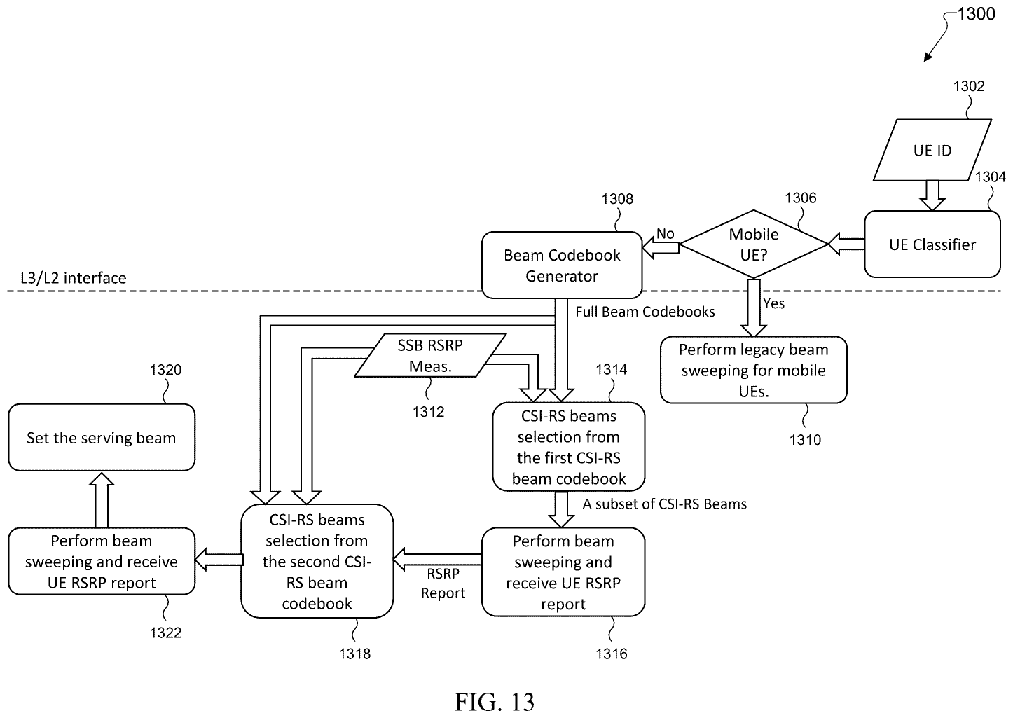

In another example, the BS could use two steps for CSI-RS beam search with two different beam codebooks, i.e., three-steps hierarchical search in total. The second codebook may typically have narrower beams than the first one. This example is shown in FIG. 13.

FIG. 13 illustrates an example of MAC layer to perform two steps of CSI-RS beam refinement for CPEs 1300 according to various embodiments of the present disclosure, as may be performed by a BS (e.g., 101-103 as illustrated in FIG. 1). An embodiment of the MAC layer to perform two steps of CSI-RS beam refinement for CPEs 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the MAC layer performs two steps of CSI-RS beam refinement for CPEs.

As illustrated in FIG. 13, in step 1302, the BS identifies the UE ID and classifies the UE in step 1304. In step 1306, the BS determines whether the UE is mobile UE. In step 1306, if the UE is the mobile UE, the BS performs the beam sweeping operation for the mobile UE in step 1310. In step 1308, the BS generates a beam codebook when the UE is identified as the non-mobile UE in step 1306. Subsequently, the BS selects the CSI-RS beams in step 1314 from the first CSI-RS beam codebook based on information of the SSB RSRP measurement in step 1312 and the full beam code book generated in step 1308. In step 1316, the BS performs, based on a subset of CSI-RS beams, sweeping operation and receives the UE RSRP report. In step 1318, the BS selects CSI-RS beam from the second CSI-RS RS beam codebook. In step 1322, the BS performs the beam sweeping operation and receives UE RSRP report. In step 1320, the BS sets the serving beam.

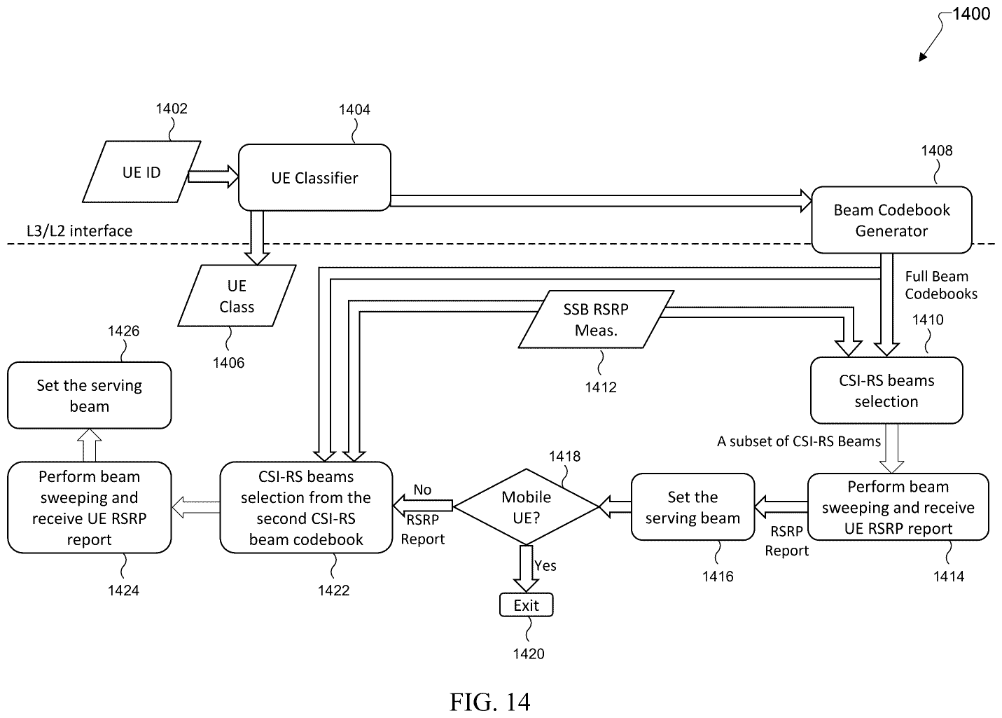

In one embodiment, the first two steps in the hierarchical search are common for mobile UEs and CPEs, but an extra step with finer beam is only used for CPEs. This requires storing or calculating three different beam codebooks; SSB, mobile CSI-RS, and CPE CSI-RS. Choosing the number of processes of beam refinement could be based on the UE class information passed from upper layers, as shown in FIG. 14.

FIG. 14 illustrates an example of MAC layer to perform two steps of CSI-RS beam refinement for CPEs 1400 and the first refinement process is common for the different UE classes according to various embodiments of the present disclosure, as may be performed by a BS (e.g., 101-103 as illustrated in FIG. 1). An embodiment of the MAC layer to perform two steps of CSI-RS beam refinement for CPEs 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, the MAC layer performs two steps of CSI-RS beam refinement for CPEs and the first refinement process is common for the different UE classes.

As illustrated in FIG. 14, in step 1402, the BS identifies the UE ID and classifies the UE in step 1404. In step 1406, the BS identifies the UE class. In step 1408, the BS generates the beam codebook. In step 1410, the BS selects the CSI-RS beams based on the SSB RSRP measurement in step 1412. In step 1414, the BS performs beam sweeping operation and receives the UE RSRP report. In step 1416, the BS sets the serving beam. In step 1418, the BS determines the UE is mobile UE. In step 1418, if the UE is mobile UE, the BS ends the procedures in step 1420. In step 1422, the BS selects the CSI-RS beams from the second CSI-RS beam codebook when the UE is identified as non-mobile UE in step 1418. In step 1424, the BS performs the beam sweeping operation and receives the UE RSRP report. In step 1426, the BS sets the serving beam.

In this case, the MAC layer does the first step of beam refinement based on the first beam codebook the MAC layer receives from the beam codebook generator block and the SSB RSRP measurements. The MAC layer could also consider the CPE location and the previous serving beams as provided in the present disclosure. Then based on the first process of CSI-RS beam refinement, the MAC layer sets the serving beam for this UE. Then, if the UE is a CPE, the

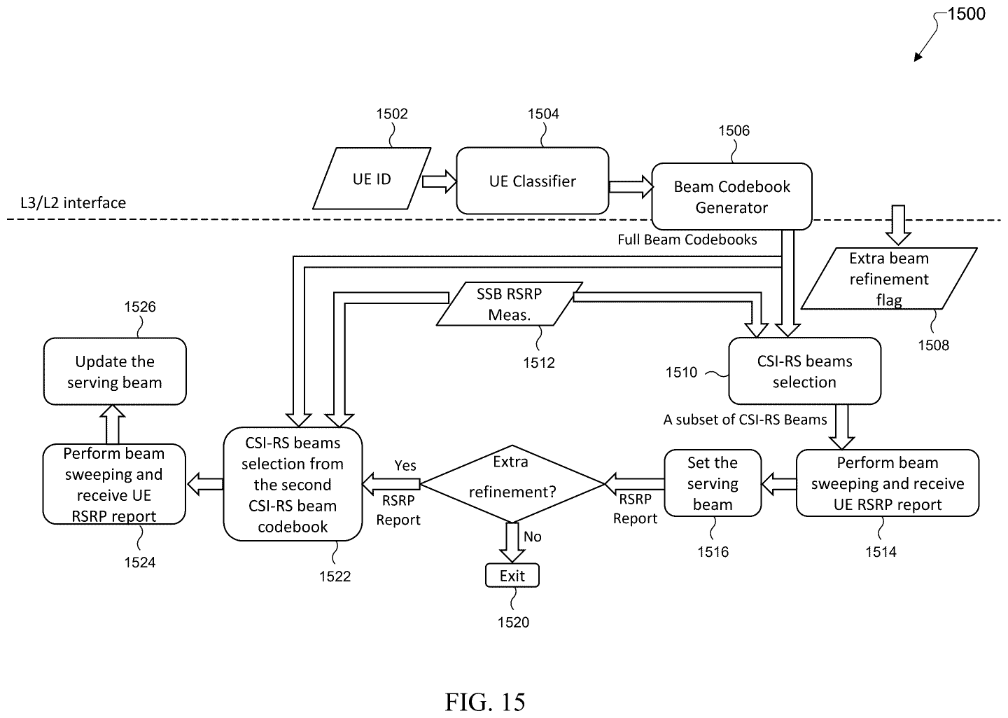

MAC layer performs another round of beam refinement based on the second CSI-RS beam codebook and update the serving beam based on that. Alternatively, upper layers could pass a control flag for the MAC layer to indicate whether or not a further CSI-RS beam refinement is needed without explicitly making it based on the UE class. This example is shown in FIG. 15.

FIG. 15 illustrates an example of MAC layer to perform two steps of CSI-RS beam refinement or one based on a control signal 1500 from upper layer and the first refinement process is common for the different UE classes and the second is triggered by a control flag passed from upper layers according to various embodiments of the present disclosure, as may be performed by a BS (e.g., 101-103 as illustrated in FIG. 1). An embodiment of the MAC layer to perform two steps of CSI-RS beam refinement or one based on a control signal 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

As illustrated in FIG. 15, in step 1502, the BS identifies the UE ID and classifies the UE in step 1504. In step 1506, the BS generates the beam codebook. In step 1508, the extra beam refinement flag is generated from the L2 to the MAC layer. In step 1510, the BS selects the CSI-RS beams based on the SSB RSRP measurement in step 1512. In step 1514, the BS performs beam sweeping operation and receives the UE RSRP report. In step 1516, the BS sets the serving beam. In step 1518, the BS determines whether the extra refinement is identified. In step 1518, if no extra refinement, the BS finishes the procedures in step 1520. In Step 1522, the BS selects the CSI-RS beams from the second CSI-RS beam codebook when the extra refinement is identified in step 1518. In step 1524, the BS performs the beam sweeping operation and receives the UE RSRP report. In step 1526, the BS updates the serving beam.

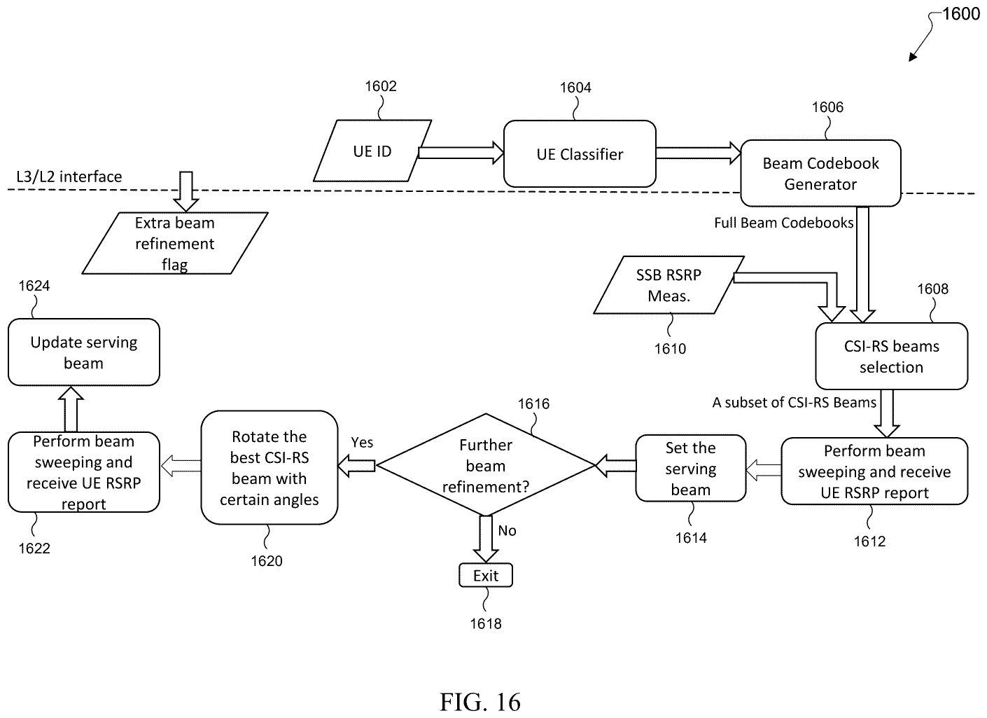

In another example, the BS could have only two codebooks (SSB and CSI-RS) common for the mobile and CPE UEs. The first two steps of the hierarchal search are common; however, an additional step is performed for CPEs. In one example, the beams searched in the third step are found by shifting the best beam from the second step horizontally and vertically. The extra refinement process could be based on the UE class or a flag passed by the upper layers. This example is shown in FIG. 16.

FIG. 16 illustrates an example of MAC layer to performs two steps of CSI-RS beam refinement or one based on a control signal 1600 from upper layers and the first refinement process is common for the different UE classes and the second is triggered by a control flag passed from upper layers according to various embodiments of the present disclosure, as may be performed by a BS (e.g., 101-103 as illustrated in FIG. 1). An embodiment of the MAC layer to performs two steps of CSI-RS beam refinement or one based on a control signal 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

As illustrated in FIG. 16, in step 1602, the BS identifies the UE ID and classifies the UE in step 1604. In step 1606, the BS generates the beam codebook. In step 1608, the BS selects the CSI-RS beams based on the SSB RSRP measurement in step 1610. In step 1612 the BS performs beam sweeping operation and receives the UE RSRP report. In step 1614, the BS sets the serving beam. In step 1616, the BS determines whether the further extra refinement is identified. In step 1616, if no extra refinement, the BS finishes the procedures in step 1618. In Step 1620, the BS rotates the best CSI-RS beam with the certain angles when the further beam refinement is identified in step 1616. In step 1622, the BS performs the beam sweeping operation and receives the UE RSRP report. In step 1624, the BS updates the serving beam.

For example, four different beams could be designed by shifting the beam form the second step by ±1°. Alternatively, the MAC layer could decide the beams in the second CSI-RS beam refinement process based on the RSRP from the first round of CSI-RS beam refinement, the SSB measurements, the CPE location, and all other information available about the CPE and the history of beam management for this user. Hence, it is more generic than the example shown in FIG. 16.

In one example, the second refinement process could be triggered based on the UE class information.

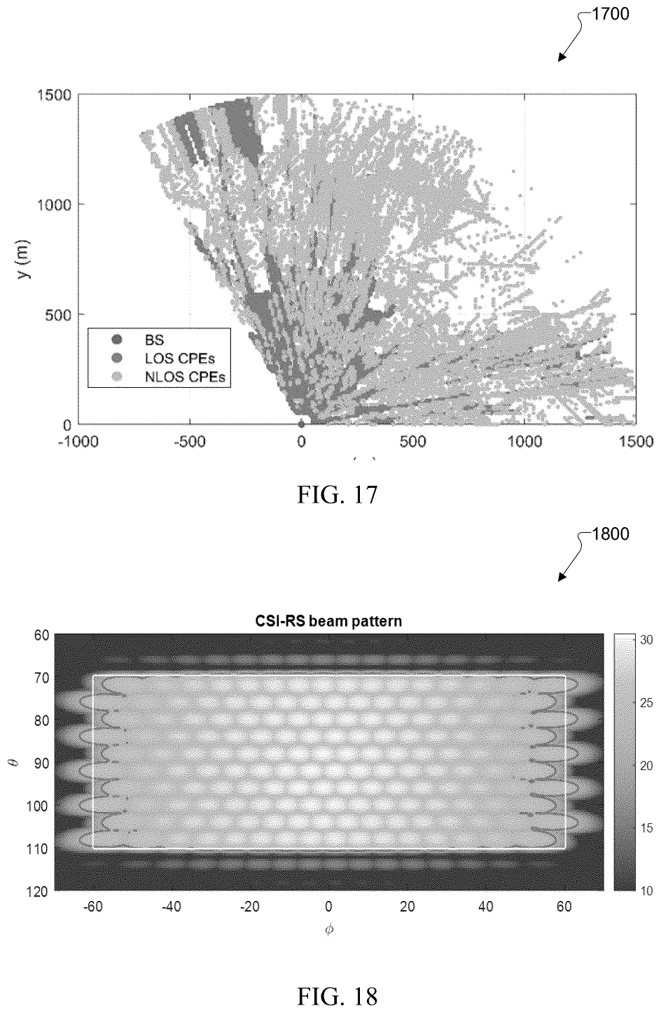

To show the possible gain from having a separate large CB for FWA, a ray-tracing simulator may be used to generate the wireless channels for CPEs uniformly distributed in the sector as shown in FIG. 17.

FIG. 17 illustrates an example of test area 1700 where a BS is located at the origin according to various embodiments of the present disclosure. An embodiment of the test area 1700 shown in FIG. 17 is for illustration only.

As illustrated in FIG. 17, the BS is located at the origin and some UEs have a clear line of sight (LOS) path, while others are non-line of sight (NLOS). CPEs location may filtered out to keep CPEs with an optimal signal to noise ratio (SNR) larger than −6 dB.

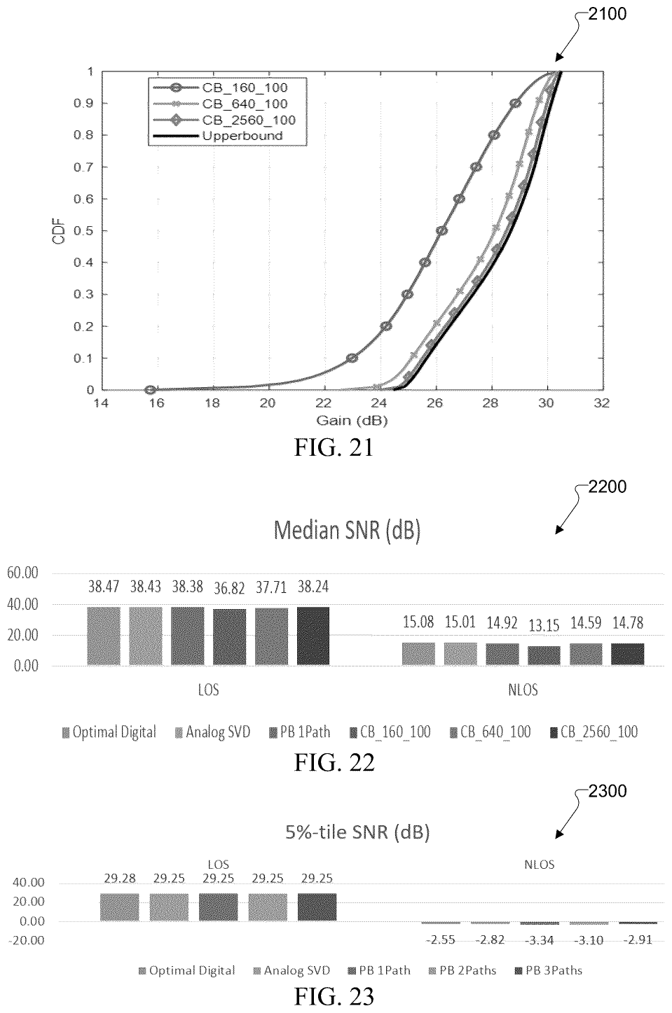

Three beam codebooks are tested, shown in FIGS. 18-20, with sizes 160, 640, and 2560 beams, respectively. The potential beam gain for the three codebooks is shown in FIG. 21, where the upper bound is achieved by using optimal digital beamforming. The figure shows that using the larger codebooks yields up to 3 dB beam gain. To observe the respective gain in our scenario, the SNR and SE are identified for all the locations shown in FIG. 17. The results are shown in FIGS. 22 and 25. It may identify that using the large codebooks for CPEs provides around 1.5 dB in terms of the SNR. This motivates using different beam code specifically for FWA.

FIG. 18 illustrates an example of two dimensional (2D) beam pattern for the 160-beam codebook 1800 according to various embodiments of the present disclosure. An embodiment of the 2D beam pattern for the 160-beam codebook 1800 shown in FIG. 18 is for illustration only.

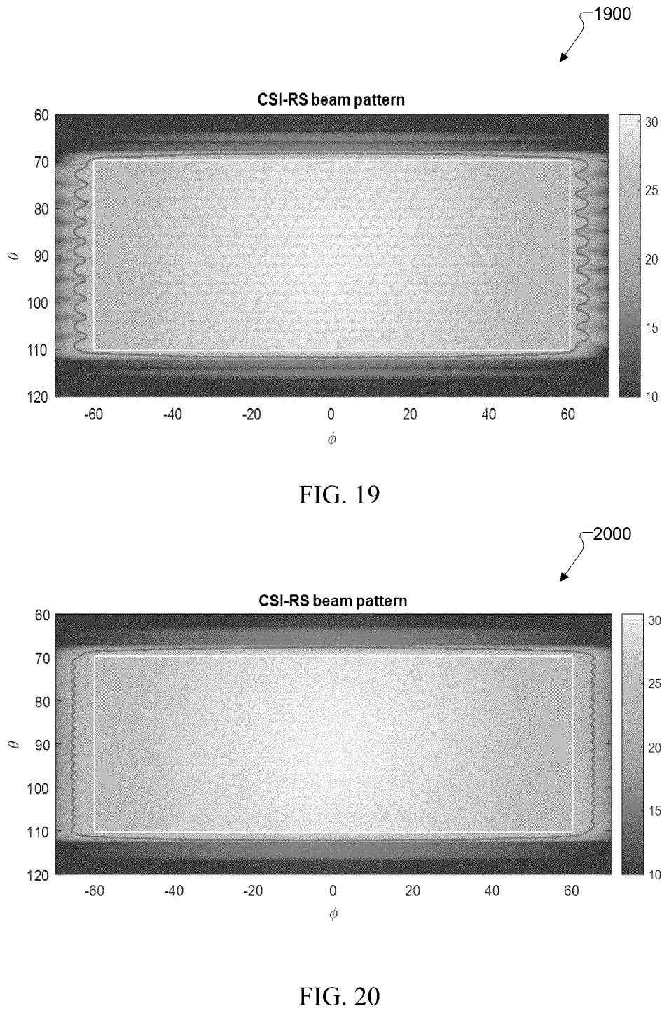

FIG. 19 illustrates an example of 2D beam pattern for the 640-beam codebook 1900 according to various embodiments of the present disclosure. An embodiment of the 2D beam pattern for the 640-beam codebook 1900 shown in FIG. 19 is for illustration only.

FIG. 20 illustrates an example of 2D beam pattern for the 2560-beam codebook 2000 according to various embodiments of the present disclosure. An embodiment of the 2D beam pattern for the 2560-beam codebook 2000 shown in FIG. 20 is for illustration only.

FIG. 21 illustrates an example of beam gain cumulative distribute function (CDF) for the different codebooks over the coverage area of interest 2100 according to various embodiments of the present disclosure. An embodiment of the beam gain CDF for the different codebooks over the coverage area of interest 2100 shown in FIG. 21 is for illustration only.

FIG. 22 illustrates an example of median SNR for different beamforming schemes for LOS and NLOS CPEs 2200 according to various embodiments of the present disclosure. An embodiment of the median SNR for different beamforming schemes for LOS and NLOS CPEs 2200 shown in FIG. 22 is for illustration only.

FIG. 23 illustrates an example of 5%-tile SNR for different beamforming schemes for LOS and NLOS CPEs 2300 according to various embodiments of the present disclosure. An embodiment of the 5%-tile SNR for different beamforming schemes for LOS and NLOS CPEs 2300 shown in FIG. 23 is for illustration only.

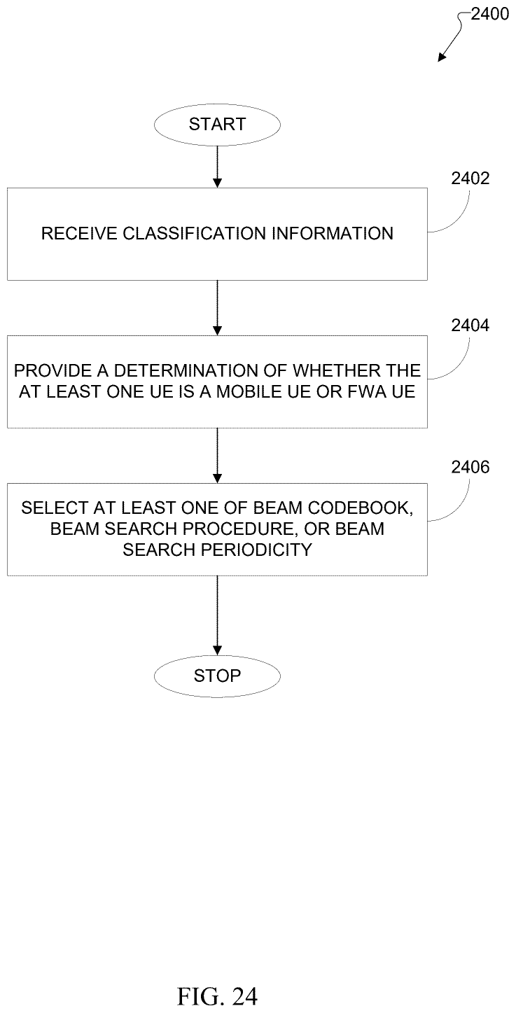

FIG. 24 illustrates a flowchart of a BS method for CPE specific beam management for FWA according to various embodiments of the present disclosure. FIG. 24 illustrates a flowchart of BS method 2400 for CPE specific beam management for FWA according to embodiments of the present disclosure. The BS method 2400 as may be performed by a BS (e.g., 101-103 as illustrated in FIG. 1). An embodiment of the BS method 2400 shown in FIG. 24 is for illustration only. One or more of the components illustrated in FIG. 24 can be implemented in specialized circuitry configured to perform the noted functions or one or more of the components can be implemented by one or more processors executing instructions to perform the noted functions.

As illustrated in FIG. 24, a BS method 2400 begins at step 2402. In step 2402, the BS receives classification information associated with at least one UE.

Subsequently, in step 2404, the BS provides a determination, based on the classification information, of whether the at least one UE is a mobile UE or a FWA UE comprising a CPE.

In such embodiment, the classification information includes an ID of the UE or a UE capability report received from the at least one UE.

In one embodiment, the classification information includes an ID of the UE or a UE capability report received from the at least one UE.

Finally, in step 2406, the BS selects, based on a determination, at least one of a beam codebook, a beam search procedure, or a beam search periodicity for a beam management operation corresponding to the mobile UE or the FWA UE.

In one embodiment, the BS identifies a CSI-RS beam codebook for the mobile UE or the FWA UE and allocates the CSI-RS beam codebook for the mobile UE or the FWA UE, respectively, a size of the CSI-RS beam codebook being allocated for the FWA UE is larger than a size of the CSI-RS beam codebook allocated for the mobile UE.

In one embodiment, the BS determines whether the at least one UE is the mobile UE or the FWA UE is determined in a L3 and transmits, to a MAC layer, the determination whether the at least one UE is the mobile UE or the FWA UE for identifying a CSI-RS beam codebook.

In such embodiment, the CSI-RS beam codebook is mapped, based on a CSI-RS beam codebook ID, with the mobile UE or the FWA UE in the MAC layer; and the CSI-RS beam codebook ID is transmitted to the MAC layer.

In one embodiment, a phase shifter weight for a full codebook is transmitted to a MAC layer to compute the full codebook for a CSI-RS beam codebook for the beam management operation or a pointing angle of each beam and a beamwidth is transmitted to the MAC layer to compute the full codebook for the CSI-RS beam codebook for the beam management operation.

In one embodiment, the BS, when the beam search procedure is selected, identifies SSB beams for the mobile UE, identifies an SSB beam among the SSB beams, the SSB beam being a best beam than other SSB beams in the SSB beams, and searches, based on the SSB beam, a subset of CSI-RS beam.

In one embodiment, the BS allocates, based on a size of a CSI-RS beam codebook for the mobile UE, the CSI-RS beam codebook for the FWA UE or allocates, based on coordinate information received from a L3, the CSI-RS beam codebook for the FWA UE in a MAC layer, the coordinate information including history of serving beams.

In one embodiment, the BS identifies at least two different CSI-RS beam codebook comprising a first codebook and a second codebook for the FWA UE. In such embodiment, the second codebook is used to allocate a beam that is narrower than a beam used for the first codebook.

In one embodiment, the BS identifies, based on the classification information or a control signal, the beam codebook for the SSB beam, the CSI-RS beam for the mobile UE, and the CSI-RS beam for the FWA UE, respectively, in order of a higher resolution. In such embodiment, the control signal is transmitted to a MAC layer from a L3, indicating a number of refinement operations required for selecting the beam codebook.

In one embodiment, the BS identifies, based on a size of the beam codebook, multiple CSI-RS beams; sweeps the multiple CSI-RS beams to identify a best CSI-RS beam for the mobile UE, a quality of the best CSI-RS beam being higher than other CSI-RS beams in the multiple CSI-RS beams; selects a subset of the multiple CSI-RS beams based on the SSB beam or an SSB, and the CSI-RS beam for the FWA UE; and tailor, based on the ID of the UE and history of the best CSI-RS beam for the FWA UE, the subset of the multiple CSI-RS beams in accordance with location information of the FWA UE.

In one embodiment, the BS performs, based on the classification information, a beam search operation in accordance with the beam search periodicity. In such embodiment, the beam search periodicity for the FWA UE is shorter than a beam search periodicity for the mobile UE. In such embodiment, the classification information includes an ID of the UE or a UE capability report received from the at least one UE.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive classification information associated with at least one user equipment (UE); and
a processor operably coupled to the transceiver, the processor configured to:
provide a determination, based on the classification information, of whether the at least one UE is a mobile UE or a fixed wireless access UE (FWA UE) comprising a customer premises equipment (CPE), and
select, based on the determination, at least one of a beam codebook, a beam search procedure, or a beam search periodicity for a beam management operation corresponding to the mobile UE or the FWA UE.

2. The BS of claim 1, wherein:
the classification information includes an identification (ID) of the UE or a UE capability report received from the at least one UE; and
the processor is further configured to, when the beam codebook is selected:
identify a channel state information-reference signal (CSI-RS) beam codebook for the mobile UE or the FWA UE, and
allocate the CSI-RS beam codebook for the mobile UE or the FWA UE, respectively, a size of the CSI-RS beam codebook being allocated for the FWA UE is larger than a size of the CSI-RS beam codebook allocated for the mobile UE.

3. The BS of claim 1, wherein:
the processor is further configured to determine whether the at least one UE is the mobile UE or the FWA UE is determined in a layer 3 (L3);
the transceiver is further configured to transmit, to a medium access control (MAC) layer, a determination whether the at least one UE is the mobile UE or the FWA UE for identifying a channel state information-reference signal (CSI-RS) beam codebook;
the CSI-RS beam codebook is mapped, based on a CSI-RS beam codebook identifier (ID), with the mobile UE or the FWA UE in the MAC layer; and
the CSI-RS beam codebook ID is transmitted to the MAC layer.

4. The BS of claim 1, wherein:
a phase shifter weight for a full codebook is transmitted to a medium access control (MAC) layer to compute the full codebook for a channel state information-reference signal (CSI-RS) beam codebook for the beam management operation; or
a pointing angle of each beam and a beamwidth is transmitted to the MAC layer to compute the full codebook for the CSI-RS beam codebook for the beam management operation.

5. The BS of claim 1, wherein:
the classification information includes an identification (ID) of the UE or a UE capability report received from the at least one UE; and
the processor is further configured to, when the beam search procedure is selected:
identify synchronization signal/physical broadcasting channel block (SSB) beams for the mobile UE,
identify an SSB beam among the SSB beams, the SSB beam being a best beam than other SSB beams in the SSB beams, and
search, based on the SSB beam, a subset of CSI-RS beam.

6. The BS of claim 5, wherein the processor is further configured to:
allocate, based on a size of a channel state information-reference signal (CSI-RS) beam codebook for the mobile UE, the CSI-RS beam codebook for the FWA UE; or
allocate, based on coordinate information received from a layer 3 (L3), the CSI-RS beam codebook for the FWA UE in a medium access control (MAC) layer, the coordinate information including history of serving beams.

7. The BS of claim 5, wherein the processor is further configured to:
identify at least two different CSI-RS beam codebook comprising a first codebook and a second codebook for the FWA UE; and
the second codebook is used to allocate a beam that is narrower than a beam used for the first codebook.

8. The BS of claim 5, wherein:
the processor is further configured to identify, based on the classification information or a control signal, the beam codebook for the SSB beam, the CSI-RS beam for the mobile UE, and the CSI-RS beam for the FWA UE, respectively, in order of a higher resolution; and
the control signal is transmitted to a medium access control (MAC) layer from a layer 3 (L3), indicating a number of refinement operations required for selecting the beam codebook.

9. The BS of claim 5, wherein the processor is further configured to:
identify, based on a size of the beam codebook, multiple CSI-RS beams;
sweep the multiple CSI-RS beams to identify a best CSI-RS beam for the mobile UE, a quality of the best CSI-RS beam being higher than other CSI-RS beams in the multiple CSI-RS beams;
select a subset of the multiple CSI-RS beams based on the SSB beam or an SSB, and the CSI-RS beam for the FWA UE; and
tailor, based on the ID of the UE and history of the best CSI-RS beam for the FWA UE, the subset of the multiple CSI-RS beams in accordance with location information of the FWA UE.

10. The BS of claim 1, wherein:
the classification information includes an identification (ID) of the UE or a UE capability report received from the at least one UE;
the processor is further configured to perform, based on the classification information, a beam search operation in accordance with the beam search periodicity; and
the beam search periodicity for the FWA UE is shorter than a beam search periodicity for the mobile UE.

11. A method of a base station (BS) in a wireless communication system, the method comprising:
receiving classification information associated with at least one user equipment (UE);
providing a determination of, based on the classification information, whether the at least one UE is a mobile UE or a fixed wireless access UE (FWA UE) comprising a customer premises equipment (CPE); and
selecting, based on the determination, at least one of a beam codebook, a beam search procedure, or a beam search periodicity for a beam management operation corresponding to the mobile UE or the FWA UE.

12. The method of claim 11, further comprising, when the beam codebook is selected:
identifying a channel state information-reference signal (CSI-RS) beam codebook for the mobile UE or the FWA UE; and
allocating the CSI-RS beam codebook for the mobile UE or the FWA UE, respectively, a size of the CSI-RS beam codebook being allocated for the FWA UE is larger than a size of the CSI-RS beam codebook allocated for the mobile UE,
wherein the classification information includes an identification (ID) of the UE or a UE capability report received from the at least one UE.

13. The method of claim 11, further comprising:
determining whether the at least one UE is the mobile UE or the FWA UE is determined in a layer 3 (L3); and
transmitting, to a medium access control (MAC) layer, a determination whether the at least one UE is the mobile UE or the FWA UE for identifying a channel state information-reference signal (CSI-RS) beam codebook,
wherein:
the CSI-RS beam codebook is mapped, based on a CSI-RS beam codebook identifier (ID), with the mobile UE or the FWA UE in the MAC layer; and
the CSI-RS beam codebook ID is transmitted to the MAC layer.

14. The method of claim 11, wherein:
a phase shifter weight for a full codebook is transmitted to a medium access control (MAC) layer to compute the full codebook for a channel state information-reference signal (CSI-RS) beam codebook for the beam management operation; or
a pointing angle of each beam and a beamwidth is transmitted to the MAC layer to compute the full codebook for the CSI-RS beam codebook for the beam management operation.

15. The method of claim 11, further comprising, when the beam search procedure is selected:
identifying synchronization signal/physical broadcasting channel block (SSB) beams for the mobile UE;
identifying an SSB beam among the SSB beams, the SSB beam being a best beam than other SSB beams in the SSB beams; and
searching, based on the SSB beam, a subset of CSI-RS beam,
wherein the classification information includes an identification (ID) of the UE or a UE capability report received from the at least one UE.

16. The method of claim 15, further comprising:
allocating, based on a size of a channel state information-reference signal (CSI-RS) beam codebook for the mobile UE, the CSI-RS beam codebook for the FWA UE; or
allocating, based on coordinate information received from a layer 3 (L3), the CSI-RS beam codebook for the FWA UE in a medium access control (MAC) layer, the coordinate information including history of serving beams.

17. The method of claim 15, further comprising identifying at least two different CSI-RS beam codebook comprising a first codebook and a second codebook for the FWA UE, wherein the second codebook is used to allocate a beam that is narrower than a beam used for the first codebook.

18. The method of claim 15, further comprising identifying, based on the classification information or a control signal, the beam codebook for the SSB beam, the CSI-RS beam for the mobile UE, and the CSI-RS beam for the FWA UE, respectively, in order of a higher resolution,
wherein the control signal is transmitted to a medium access control (MAC) layer from a layer 3 (L3), indicating a number of refinement operations required for selecting the beam codebook.

19. The method of claim 15, further comprising:
identifying, based on a size of the beam codebook, multiple CSI-RS beams;
sweeping the multiple CSI-RS beams to identify a best CSI-RS beam for the mobile UE, a quality of the best CSI-RS beam being higher than other CSI-RS beams in the multiple CSI-RS beams;
selecting a subset of the multiple CSI-RS beams based on the SSB beam or an SSB, and the CSI-RS beam for the FWA UE; and
tailoring, based on the ID of the UE and history of the best CSI-RS beam for the FWA UE, the subset of the multiple CSI-RS beams in accordance with location information of the FWA UE.

20. The method of claim 11, further comprising performing, based on the classification information, a beam search operation in accordance with the beam search periodicity,
wherein:
the classification information includes an identification (ID) of the UE or a UE capability report received from the at least one UE; and
the beam search periodicity for the FWA UE is shorter than a beam search periodicity for the mobile UE.
